(19) United States
(12) Patent Application Publication
(10) Pub. No.: US 2007/0219314 A1
(43) Pub. Date: Sep. 20, 2007

(54) CURABLE COMPOSITION, CURED PRODUCT, AND LAMINATE

(75) Inventors: Noriyasu Shinohara, Tokyo (JP); Shinji Usui, Tokyo (JP); Takayoshi Tanabe, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: JSR Corporation, Chuo-ku (JP)

(21) Appl. No.: 11/575,978

(22) PCT Filed: Oct. 14, 2005
(86) PCT No.: PCT/NL05/00738

§ 371 Date: Mar. 26, 2007

(30) Foreign Application Priority Data
Oct. 27, 2004 (JP) 2004-312391

(51) Int. Cl. C08G 18/28; C08G 18/67; C08K 9/04; C09D 175/16

(52) U.S. Cl. 524/612

(57) ABSTRACT

To provide a curable composition exhibiting excellent applicability and capable of forming a coating having high hardness, showing a small amount of curling after hot water immersion, and exhibiting excellent scratch resistance on the surface of a substrate, and a cured product of the composition. [Means for the Solution] A curate composition, comprising: (A) 5 to 70 wt % of metal oxide particles having a refractive index of 1.50 or more, to which an organic compound containing a polymerizable unsaturated group is bonded; and (B) 10 to 50 wt % of a compound shown by the following formula (I), the amount of each component being based on the total amount of the composition excluding a solvent, and a cured product produced by curing the curate composition.

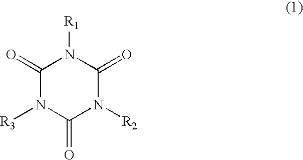

The present invention relates to a curable composition, a cured product of the curable composition, and a laminate. More particularly, the present invention relates to a curable composition having excellent applicability which is capable of forming a coating (film) having a high refractive index, high hardness, excellent scratch resistance, and excellent adhesion to the adjacent layer such as a substrate or a low-refractive-index layer on the surface of various substrates such as plastic (polycarbonate, poly(methyl methacrylate), polystyrene, polyester, polyolefin, epoxy resin, melamine resin, triacetyl cellulose resin, ABS resin, AS resin, norbornene resin, etc.), metal, wood, paper, glass, and slate, and to a hard-coating cured film exhibiting excellent chemical resistance and low curling properties.

In recent years, a curable composition having excellent applicability and capable of forming a cured film with excellent hardness, flexibility, scratch resistance, abrasion resistance, low curling properties (cured film shows a small degree of warping), adhesion, transparency, chemical resistance, and appearance on various substrates has been demanded as a protective coating material for preventing scratches or stains on the surface of various substrates; an adhesive and a sealing material for various substrates; and a binder material for printing ink.

In applications of antireflective films, such as film-type liquid crystal elements, touch panels, or plastic optical parts, a curable composition capable of forming a cured film having a high refractive index has been demanded.

Various compositions have been proposed to satisfy this demand. However, a curable composition exhibiting excellent applicability and capable of producing a cured film exhibiting excellent hardness and flexibility and having low curling properties has not yet been obtained.

In the hard coating application in which a high refractive index is not required, a technology of using a composition including particles obtained by modifying the surface of colloidal silica having a refractive index of about 1.45 with methacryloxysilane and an acrylate as a radiation (photo) curable coating material has been proposed in Japanese Translation of PCT International Publication No. 58-500251. This type of radiation curable composition has been widely used due to excellent applicability and the like Japanese Patent Application Laid-open No. 10-273595, Japanese Patent Application Laid-open No. 2000-143924, Japanese Patent Application Laid-open No. 2000-281863, Japanese Patent Application Laid-open No. 2000-49077, Japanese Patent Application Laid-open No. 2001-89535, Japanese Patent Application Laid-open No. 2001-200023.

Patent documents Japanese Patent Application Laid-open No. 5-320289 and International Patent Application No. WO/9711129 disclose a photocurable composition including an acrylate having an isocyanurate cyclic structure and colloidal silica. However, these documents do not describe a reduction of curling properties.

Japanese Patent Application Laid-open No. 2003-313329 discloses a technology of reducing curling of a hard coating. However, since a treatment temperature as high as 150° C. is required, this technology is not suitable for film applications such as a triacetyl cellulose (TAC) film. Moreover, this technology requires a thermal expansion capsule as an essential component, and particles with a high refractive index are not incorporated.

Japanese Patent Application Laid-open No. 2004-141732 discloses a cured product of a composition including a compound having an isocyanurate cyclic structure. However, this composition does not contain particles. In the patent document 11, hardness is provided by increasing the film thickness. In addition, this composition does not contain particles having a high refractive index.

However, when applying a layer of a low-refractive-index film onto a cured product of the above-mentioned composition and using the resulting laminate as an antireflective film, although the antireflective effect is improved to some extent, the antireflective film does not exhibit well-balanced hardness, flexibility, and curling properties.

In particular, in the case of a film obtained by applying a hard coating to a TAC film as a substrate, when immersing the film in alkaline hot water for saponification (hydrophilic treatment) of the TAC film after laminating a hard coating, the degree of curling cannot be reduced.

The present invention has been achieved in view of the above-described problems. An objective of the present invention is to provide a curable composition having excellent applicability which is capable of forming a coating (film) having high hardness, and excellent flexibility and showing a small degree of curling when immersed in hot water on the surface of various substrates, and a hard-coating cured film having excellent steel wool resistance and chemical resistance.

According to the present invention a curable composition is provided, comprising: (A) 5 to 70 wt % of metal oxide particles having a refractive index of 1.50 or more, to which an organic compound including a polymerizable unsaturated group is bonded; and (B) 10 to 50 wt % of a compound shown by the following formula (1), the amount of each component being based on the total amount of the composition excluding a solvent, 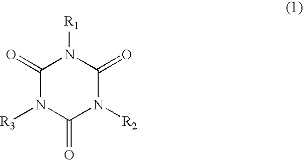
wherein R¹, R², and R³ individually represent monovalent organic groups, with at least two of R¹, R², and R³ being —R⁴OCOCR⁵═CH₂, wherein R⁴ represents a divalent organic group having 2 to 8 carbon atoms, and R⁵ represents a hydrogen atom or a methyl group.

According to the present invention, a curable composition having a high refractive index and excellent applicability and capable of forming a coating (film) having high hardness, excellent scratch resistance, low curling properties (in particular, low curling properties after hot water immersion treatment), excellent flexibility, and high transparency on the surface of various substrates, and a cured film of the composition can be provided.

Embodiments of the curable composition, the cured product of the curable composition, and the laminate of the present invention are described below in detail.

I. Curable Composition

The curable composition of the present invention includes (A) metal oxide particles having a refractive index of 1.50 or more, to which an organic compound including a polymerizable unsaturated group is bonded; and (B) a compound shown by the formula (1).

The components of the curable composition of the present invention are described below in detail.

1. Metal Oxide Particles (A) Having Refractive Index of 1.50 or More to which Organic Compound Containing Polymerizable Unsaturated Group is Bonded

The component (A) used in the present invention is particles prepared by bonding (Aa) metal oxide particles having a refractive index or more 1.50 or more and (Ab) an organic compound containing a polymerizable unsaturated group (hereinafter referred to as “reactive particles”). The components (Aa) and (Ab) may be bonded through a covalent bond or a noncovalent bond such as by physical adsorption.

(1) Metal Oxide Particles (Aa)

The metal oxide particles (Aa) used in the present invention are preferably metal oxide particles of at least one element selected from the group consisting of aluminum, zirconium, titanium, zinc, germanium, indium, tin, antimony, and cerium, in order to obtain a high refractive index of 1.50 or more and to ensure that the resulting curable composition produces a hard and colorless cured film. For example, silica particles containing silicon as the major component are not suitable for the present invention, since the silica particles have a refractive index of about 1.45 so that a high refractive index is not obtained.

As examples of the metal oxide particles (Aa), alumina particles, zirconia particles, titanium oxide particles, zinc oxide particles, germanium oxide particles, indium oxide particles, tin oxide particles, antimony tin oxide (ATO) particles, indium tin oxide (ITO) particles, antimony oxide particles, cerium oxide particles, and the like can be given. Of these, alumina particles, zirconia particles, and antimony oxide particles are preferable from the viewpoint of high hardness, with zirconia particles being particularly preferable. A high-refractive-index cured film may be obtained by using oxide particles of zirconium, titanium, or the like. A cured film may be provided with electrical conductivity by using ATO particles or the like. These particles may be used either individually or in combination of two or more. It is preferable that the oxide particles (Aa) be in the form of powder or dispersed in a liquid. When using the oxide particles (Aa) in the form of a liquid dispersion, the dispersion medium is preferably an organic solvent from the viewpoint of miscibility with other components and dispersibility of the particles. As examples of the organic solvent, alcohols such as methanol, ethanol, isopropanol, butanol, and octanol; ketones such as acetone, methyl ethyl ketone, methyl isobutyl ketone, and cyclohexanone; esters such as ethyl acetate, butyl acetate, ethyl lactate, γ-butyrolactone, propylene glycol monomethyl ether acetate, and propylene glycol monoethyl ether acetate; ethers such as ethylene glycol monomethyl ether and diethylene glycol monobutyl ether; aromatic hydrocarbons such as benzene, toluene, and xylene; amides such as dimethylformamide, dimethylacetamide, and N-methylpyrrolidone; and the like can be given. In particular, methanol, isopropanol, butanol, methyl ethyl ketone, methyl isobutyl ketone, ethyl acetate, butyl acetate, toluene, and xylene are preferable.

The metal oxide particles (Aa) have a number average particle diameter measured by electron microscopy of preferably 0.001 to 2 μm, still more preferably 0.001 to 0.2 μm, and particularly preferably 0.001 to 0.1 μm. If the number average particle diameter exceeds 2 μm, the resulting cured product may exhibit decreased transparency, or the surface state of the resulting film may be impaired. In order to improve the dispersibility of the particles, various surfactants or amines may be added.

As commercially available products of zirconia particles, EP, UEP, RC (manufactured by Daiichi Kigenso Kagaku Kogyo Co., Ltd.), N-PC, PCS (manufactured by Nippon Denko Co., Ltd.), TZ-3Y-E, TZ-4YS, TZ-6YS, TZ-8YS, TZ-10YS, and TZ-0 (manufactured by Tosoh Corp.), and the like can be given.

An aqueous dispersion product of alumina is commercially available as Alumina Sol-100, Sol-200, Sol-520 (manufactured by Nissan Chemical Industries, Ltd.); an isopropanol dispersion product of alumina is commercially available as AS-150I (manufactured by Sumitomo Osaka Cement Co., Ltd.); a toluene dispersion product of alumina is commercially available as AS-150T (manufactured by Sumitomo Osaka Cement Co., Ltd.); a toluene dispersion product of zirconia is commercially available as HXU-110JC (manufactured by Sumitomo Osaka Cement Co., Ltd.); an aqueous dispersion product of zinc antimonate powder is commercially available as Celnax (manufactured by Nissan Chemical Industries, Ltd.); a powder or solvent dispersion product of alumina, titanium oxide, tin oxide, indium oxide, or zinc oxide is commercially available as NanoTek (manufactured by C.I. Kasei Co., Ltd.); an aqueous dispersion sol of antimony tin oxide is commercially available as SN-100D (manufactured by Ishihara Sangyo Kaisha, Ltd.); ITO powder is commercially available from Mitsubishi Materials Corporation; and an aqueous dispersion product of cerium oxide is commercially available as Needral (manufactured by Taki Chemical Co., Ltd.).

The shape of the metal oxide particle (Aa) may be globular, hollow, porous, rod-like, plate-like, fibrous, or amorphous. The metal oxide particle (Aa) is preferably globular. The specific surface area of the metal oxide particles (Aa) (determined by BET method using nitrogen) is preferably 10 to 1000 m²/g, and still more preferably 100 to 500 m²/g. The metal oxide particles (Aa) may be used in the form of dry powder or a dispersion in water or an organic solvent. For example, a liquid dispersion of fine metal oxide particles known in the art may be used. In applications in which excellent transparency is required for the resulting cured product, it is preferable to use a liquid dispersion of the metal oxide particles.

(2) Organic Compound (Ab)

The organic compound (Ab) used in the present invention is a compound containing a polymerizable unsaturated group. The organic compound (Ab) preferably further contains a group shown by the following formula (2). The organic compound (Ab) preferably contains a group [—O—C(═O)—NH—] and at least one of groups [—O—C(═S)—NH—] and [—S—C(═O)—NH—]. The organic compound (Ab) is preferably a compound containing a silanol group in the molecule or a compound which forms a silanol group by hydrolysis. 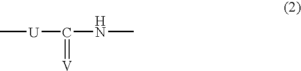
wherein U represents NH, O (oxygen atom), or S (sulfur atom), and V represents O or S.
(i) Polymerizable Unsaturated Group

There are no specific limitations to the polymerizable unsaturated group included in the organic compound (Ab). As preferable examples of the polymerizable unsaturated group, an acryloyl group, methacryloyl group, vinyl group, propenyl group, butadienyl group, styryl group, ethynyl group, cinnamoyl group, maleate group, and acrylamide group can be given.

The polymerizable unsaturated group is a structural unit which undergoes addition polymerization in the presence of active radical species.

(ii) Group Shown by Formula (2)

The group [—U—C(═V)—NH—] included in the organic compound and shown by the formula (2) is [—O—C(═O)—NH—], [—O—C(═S)—NH—], [—S—C(═O)—NH—], [—NH—C(═O)—NH—], [—NH—C(═S)—NH—], or [—S—C(═S)—NH—]. These groups may be used either individually or in combination of two or more. In particular, it is preferable to use the group [—O—C(═O)—NH—] and at least one of the groups [—O—C(═S)—NH—] and [—S—C(═O)—NH—] in combination from the viewpoint of thermal stability.

It is presumed that the group [—U—C(═V)—NH—] shown by the formula (2) causes a moderate cohesive force to occur between the molecules due to a hydrogen bond to provide the resulting cured product with properties such as excellent mechanical strength, superior adhesion to a substrate or an adjacent layer such as a high-refractive-index layer, and excellent heat resistance.

(iii) Silanol Group or Group which Forms Silanol Group by Hydrolysis

The organic compound (Ab) is preferably a compound containing a silanol group in the molecule or a compound which forms a silanol group by hydrolysis. As the compound which produces a silanol group, a compound in which an alkoxy group, aryloxy group, acetoxy group, amino group, halogen atom, or the like is bonded to a silicon atom can be given. In particular, a compound in which an alkoxy group or an aryloxy group is bonded to a silicon atom, specifically, a compound containing an alkoxysilyl group or a compound containing an aryloxysilyl group is preferable.

A silanol group or a silanol group-forming site of the compound which produces a silanol group is a structural unit which bonds to the oxide particles (Aa) by condensation or condensation occurring after hydrolysis.

(iv) Preferable Embodiment

As a preferable example of the organic compound (Ab), a compound shown by the following formula (3) can be given.

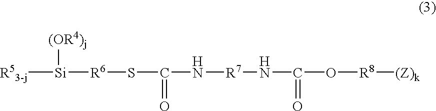

In the formula (3), R⁴ and R⁵ individually represent a hydrogen atom or an alkyl group or aryl group having 1 to 8 carbon atoms, such as a methyl group, ethyl group, propyl group, butyl group, octyl group, phenyl group, or xylyl group. j represents an integer from 1 to 3.

As examples of the group shown by [(R⁴⁰)ⱼR⁵₃₋ⱼSi—], a trimethoxysilyl group, triethoxysilyl group, triphenoxysilyl group, methyldimethoxysilyl group, dimethylmethoxysilyl group, and the like can be given. Of these groups, a trimethoxysilyl group or a triethoxysilyl group is preferable.

R⁶ represents a divalent organic group having an aliphatic structure or an aromatic structure having 1 to 12 carbon atoms, and may include a linear, branched, or cyclic structure. As specific examples of such an organic group, methylene, ethylene, propylene, butylene, hexamethylene, cyclohexylene, phenylene, xylylene, dodecamethylene, and the like can be given.

R⁷ represents a divalent organic group selected from divalent organic groups having a molecular weight of 14 to 10,000, and preferably 76 to 500. As specific examples of such an organic group, linear polyalkylene groups such as hexamethylene, octamethylene, and dodecamethylene; divalent alicyclic or polycyclic organic groups such as cyclohexylene and norbornylene; divalent aromatic groups such as phenylene, naphthylene, biphenylene, and polyphenylene; and alkyl-substituted products or aryl-substituted products of these groups can be given. These divalent organic groups may include an atomic group containing an element other than a carbon atom and a hydrogen atom, and may include a polyether bond, polyester bond, polyamide bond, or polycarbonate bond.

R⁸ represents an organic group with a valence of “k+1”, and is preferably selected from linear, branched, or cyclic saturated or unsaturated hydrocarbon groups.

Z represents a monovalent organic group containing a polymerizable unsaturated group, which undergoes an intermolecular crosslinking reaction in the presence of active radical species, in the molecule. k represents an integer preferably from 1 to 20, still more preferably from 1 to 10, and particularly preferably from 1 to 5.

As specific examples of the compound shown by the formula (3), compounds shown by the following formulas (4-1) and (4-2) can be given. 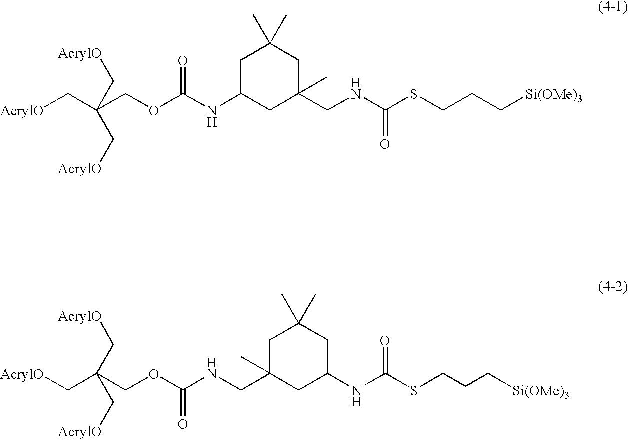
wherein “Acryl” represents an acryloyl group, and “Me” represents a methyl group.

The organic compound (Ab) used in the present invention may be synthesized by using a method disclosed in Japanese Patent Application Laid-open No. 9-100111, for example. The organic compound (Ab) is preferably produced by reacting mercaptopropyltrimethoxysilane and isophorone diisocyanate at 60 to 70° C. for about several hours in the presence of dibutyltin dilaurate, adding pentaerythritol triacrylate to the reaction product, and reacting the mixture at 60 to 70° C. for about several hours.

(3) Reactive Particles (A)

The organic compound (Ab) containing a silanol group or a group which produces a silanol group by hydrolysis is mixed with the metal oxide particles (Aa) and hydrolyzed to bond the metal oxide particles (Aa) and the organic compound (Ab). The amount of organic polymer component (i.e. hydrolysate and condensate of hydrolysable silane) in the resulting reactive particles (A) may be determined, by thermogravimetric analysis from room temperature to 800° C. in air, as a constant weight loss (%) when completely burning the dry powder in air, for example.

The amount of the organic compound (Ab) bonded to the oxide particles (Aa) is preferably 0.01 wt % or more, still more preferably 0.1 wt % or more, and particularly preferably 1 wt % or more of 100 wt % of the reactive particles (A) (metal oxide particles (Aa) and organic compound (Ab) in total). If the amount of the organic compound (Ab) bonded to the metal oxide particles (Aa) is less than 0.01 wt %, the dispersibility of the reactive particles (A) in the composition may be insufficient, whereby the resulting cured product may exhibit insufficient transparency and scratch resistance. The amount of the metal oxide particles (Aa) in the raw material when preparing the reactive particles (A) is preferably 5 to 99 wt %, and still more preferably 10 to 98 wt %.

The amount (content) of the reactive particles (A) in the curable composition is preferably 20 to 80 wt %, and still more preferably 30 to 50 wt % for 100 wt % of the total amount of the composition excluding an organic solvent (total amount of components (A), (B), and (C)). If the amount is less than 20 wt %, the resulting cured product may exhibit insufficient hardness or may have a low refractive index. If the amount exceeds 80 wt %, film formability may be insufficient. In this case, the oxide particles (Aa) preferably account for 65 to 95 wt % of the reactive particles (A). The amount of the reactive particles (A) refers to the solid content. When the reactive particles (A) are used in the form of a liquid dispersion, the amount of the reactive particles (A) excludes the amount of dispersion medium.

2. Compound (B) Shown by Formula (1)

The component (B) used in the present invention reduces curling and provides flexibility while maintaining the hardness of the resulting cured product. Moreover, the component (B) improves the steel wool scratch resistance of a laminate including the resulting cured product and a specific low-refractive-index layer.

The compound (B) shown by the following formula (1), which is the component (B) used in the present invention, is an isocyanuric acid derivative containing a polymerizable unsaturated group. 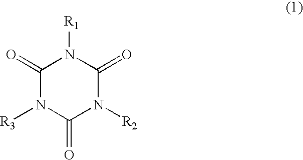
wherein R¹, R², and R³ individually represent monovalent organic groups, with at least two of R¹ to R³ being —R⁴OCOCR⁵═CH₂, R⁴ represents a divalent organic group having 2 to 8 carbon atoms, and R⁵ represents a hydrogen atom or a methyl group.

The component (B) preferably contains two or more polymerizable unsaturated groups in the molecule. The polymerizable unsaturated group is preferably a (meth)acrylate group, although the polymerizable unsaturated group is not particularly limited. If the component (B) preferably contains two or more polymerizable unsaturated groups, the crosslink density is increased so that a decrease in hardness can be reduced.

As specific examples of the component (B) which may be used in the present invention, tris(2-hydroxyethyl)isocyanurate tri(meth)acrylate, tris(2-hydroxyethyl)isocyanurate di(meth)acrylate, tris(2-hydroxyethyl)isocyanurate mono(meth)acrylate, bis(2-hydroxyethyl)isocyanurate di(meth)acrylate, bis(2-hydroxyethyl)isocyanurate mono(meth)acrylate, (meth)acrylate of ethylene oxide (EO), propylene oxide, or caprolactame addition product of the starting alcohol of these compounds, and the like can be given. Of these, isocyanuric acid EO (ethylene oxide) modified tri(meth)acrylate is particularly preferable.

As commercially available products which may be suitably used as the compound (B), Aronix M-313, M-315, M-325, M-326, M-327 (manufactured by Toagosei Co., Ltd.), SR-368 (manufactured by Sartomer Company), and the like can be given. The above compounds may be used either individually or in combination of two or more.

The compound (B) is used in the present invention in an amount of preferably 10 to 50 wt %, still more preferably 20 to 50 wt %, and particularly preferably 35 to 50 wt % for 100 wt % of the total amount of the composition excluding an organic solvent (total amount of components (A), (B), and (C)). If the amount is less than 10 wt %, the resulting cured film may be curled. If the amount exceeds 70 wt %, the resulting cured film may exhibit insufficient hardness.

The amount of the compound (B) is preferably 20 wt % or more, still more preferably 40 wt % or more, and particularly preferably 60 wt % or more of 100 wt % of the total (meth)acrylate component in the composition of the present invention excluding the component (A).

If the amount is 20 wt % or more, warping of the resulting cured film can be effectively reduced. The total (meth)acrylate component excluding the component (A) used herein refers to the (meth)acrylate component included in the total soluble component excluding the component (A) which is insoluble particles. Specifically, the total (meth)acrylate component refers to the total amount of the components (B) and (C) (component (C) is described later).

3. Polyfunctional (Meth)Acrylate Compound (C) Other than Components (A) and (B)

The compound (C) is suitably used to improve the flexibility of the resulting cured film.

The polyfunctional (meth)acrylate compound as the component (C) is a (meth)acrylate monomer containing two or more polymerizable unsaturated groups in the molecule. The polyfunctional (meth)acrylate compound is suitably used to improve the curability and hardness of the resulting cured film. The expression “polyfunctional” used herein means that the (meth)acrylate compound contains two or more (meth)acryloyl groups in the molecule. From the viewpoint of film formability and hardness, a tri- or higher functional (meth)acrylate compound is preferable, with a penta- or higher functional (meth)acrylate compound being still more preferable.

As preferable examples of the polyfunctional (meth)acrylate compound, pentaerythritol triacylate, dipentaerythritol hexaacrylate, dipentaerythritol pentaacrylate, and a compound shown by the following formula (5) can be given.

As commercially available products of the polyfunctional (meth)acrylate compound, Kayarad DPHA, PET-30 (manufactured by Nippon Kayaku Co., Ltd.), Aronix M-305, M-400, M-402, M-404 (manufactured by Toagosei Co., Ltd.), NK Ester A-TMM-3LM-N (manufactured by Shin-Nakamura Chemical Co., Ltd.), and the like can be given.

A compound shown by the following formula (5) can improve the flexibility and anti-curling properties of the resulting cured film without affecting the hardness of the cured film to a large extent. 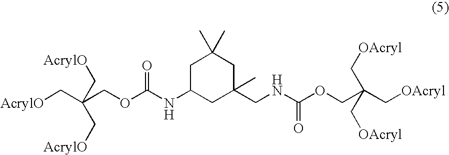
wherein “Acryl” represents an acryloyl group.

As commercially available products of the urethane (meth)acrylate used in the present invention, Beamset 102, 502H, 505A-6, 510, 550B, 551B, 575, 575CB, EM-90, EM92 (manufactured by Arakawa Chemical Industries, Ltd.), Photomer 6008, 6210 (manufactured by San Nopco, Ltd.), NK Oligo U-2PPA, U-4HA, U-6HA, H-15HA, UA-32PA, U-324A, U-4H, U-6H (manufactured by Shin-Nakamura Chemical Co., Ltd.), Aronix M-1100, M-1200, M-1210, M-1310, M-1600, M-1960 (manufactured by Toagosei Co., Ltd.), AH-600, AT606, UA-306H (manufactured by Kyoeisha Chemical Co., Ltd.), Kayarad UX-2201, UX-2301, UX-3204, UX-3301, UX-4101, UX-6101, UX-7101 (manufactured by Nippon Kayaku Co., Ltd.), UV-1700B, UV-3000B, UV-6100B, UV-6300B, UV-7000, UV-2010B (manufactured by Nippon Synthetic Chemical Industry Co., Ltd.), Art Resin UN-1255, UN-5200, HDP-4T, HMP-2, UN-901T, UN-3320HA, UN-3320HB, UN-3320HC, UN-3320HS, H-61, HDP-M20 (manufactured by Negami Chemical Industrial Co., Ltd.), Ebecryl 6700, 204, 205, 220, 254, 1259, 1290K, 1748, 2002, 2220, 4833, 4842, 4866, 5129, 6602, 8301 (manufactured by Daicel UBC Co., Ltd.), and the like can be given. Of these, U-6HA is preferable as a urethane (meth)acrylate containing three or more (meth)acrylate groups.

The component (C) is used in the present invention in an amount of preferably 10 to 50 wt %, and still more preferably 10 to 30 wt % for 100 wt % of the total amount of the composition excluding an organic solvent (total amount of components (A), (B), and (C)). If the amount exceeds 50 wt %, the resulting cured film may exhibit insufficient flexibility and anti-curling properties. If the amount is less than 10 wt %, the resulting cured film may exhibit insufficient hardness.

4. Radical Polymerization Initiator (D)

The composition of the present invention may include (D) a radical polymerization initiator, as required.

As examples of the radical polymerization initiator (D), a compound which thermally generates active radical species (heat polymerization initiator), and a compound which generates active radical species upon application of radiation (light) (radiation (photo) polymerization initiator) can be given.

There are no specific limitations to the radiation (photo) polymerization initiator insofar as the initiator decomposes and generates radicals upon irradiation to initiate polymerization. Examples of the radiation (photo) polymerization initiator include acetophenone, acetophenone benzyl ketal, 1-hydroxycyclohexyl phenyl ketone, 2,2-dimethoxy-1,2-diphenylethan-1-one, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2-benzyl-2-dimethylamino-1-(4-morpholinophenyl)-butanone-1,4-(2-hydroxyethoxy)phenyl-(2-hydroxy-2-propyl)ketone, 2,4,6-trimethylbenzoyl diphenylphosphine oxide, bis-(2,6-dimethoxybenzoyl)-2,4,4-trimethylpentylphosphine oxide, oligo(2-hydroxy-2-methyl-1-(4-(1-methylvinyl)phenyl)propanone), and the like.

As commercially available products of the radiation (photo) polymerization initiator, Irgacure 184, 369, 651, 500, 819, 907, 784, 2959, CGI1700, CGI1750, CGI1850, CG24-61, Darocur 1116, 1173 (manufactured by Ciba Specialty Chemicals Inc.), Lucirin TPO (manufactured by BASF), Ebecryl P36 (manufactured by UCB), Esacure KIP150, KIP65LT, KIP100F, KT37, KT55, KTO46, KIP75/B (manufactured by Lamberti), and the like can be given.

The radical polymerization initiator (D), which is used in the present invention as an optional component, is used in an amount of preferably 0.01 to 10 wt %, and still more preferably 0.1 to 5 wt % for 100 wt % of the total amount of the composition excluding an organic solvent (total amount of components (A) to (D)). If the amount is less than 0.01 wt %, the resulting cured product may exhibit insufficient hardness. If the amount exceeds 10 wt %, the inside (lower layer) of the cured product may remain uncured.

When curing the composition of the present invention, a photoinitiator and a heat polymerization initiator may be used in combination, as required.

As preferable examples of the heat polymerization initiator, peroxides and azo compounds can be given. Specific examples include benzoyl peroxide, t-butyl peroxybenzoate, azobisisobutyronitrile, and the like.

5. Organic Solvent (E)

The composition of the present invention may be diluted with (E) an organic solvent in order to adjust the thickness of a coating formed by using the composition. In the case where the composition is used as an antireflective film or a coating material, the viscosity of the composition is usually 0.1 to 50,000 mPa·s/25° C., and preferably 0.5 to 10,000 mPa·s/25° C.

There are no specific limitations to the organic solvent (E). However, since the compound used as the component (B) has high crystallinity, it is preferable to use a high-boiling solvent so that the composition of the present invention is uniformly applied. As specific examples of the organic solvent (E), alcohols such as methanol, ethanol, isopropanol, butanol, and octanol; ketones such as acetone, methyl ethyl ketone (MEK), methyl isobutyl ketone, and cyclohexanone; esters such as ethyl acetate, butyl acetate, ethyl lactate, γ-butyrolactone, propylene glycol monomethyl ether acetate, and propylene glycol monoethyl ether acetate; ethers such as ethylene glycol monomethyl ether and diethylene glycol monobutyl ether; aromatic hydrocarbons such as benzene, toluene, and xylene; amides such as dimethylformamide, dimethylacetamide, and N-methylpyrrolidone; and the like can be given. Of these, high-boiling solvents such as methyl isobutyl ketone, cyclohexanone, propylene glycol monomethyl ether acetate, propylene glycol monoethyl ether acetate, toluene, and xylene are preferable.

The organic solvent (E) is used in the composition of the present invention in an amount of usually 30 to 80 wt %, and preferably 40 to 60 wt % of the total amount of the composition. If the amount of the organic solvent (E) is 30 to 80 wt %, the composition exhibits excellent applicability.

6. Other Components

The curable composition of the present invention may include a photosensitizer, polymerization inhibitor, polymerization adjuvant, leveling agent, wettability improver, surfactant, plasticizer, UV absorber, antioxidant, antistatic agent, inorganic filler, pigment, dye, or the like insofar as the effects of the present invention are not impaired.

7. Preparation of Composition

The composition of the present invention is prepared as follows. A reaction vessel equipped with a stirrer is charged with a reactive particle liquid dispersion (component (A)), a radiation (photo) polymerization initiator (component (D)), a compound shown by the formula (1) (component (B)), a polyfunctional (meth)acrylate (component (C)), and a urethane (meth)acrylate (component (C)). The mixture is stirred at 35 to 45° C. for two hours to obtain the composition of the present invention.

When replacing the solvent with a solvent (B) differing from a solvent (A) used in the reactive particle liquid dispersion, the solvent (B) is also added to the mixture in an amount 1.3 times the amount of the solvent (A) of the reactive particle liquid dispersion, and the mixture is stirred under the same conditions. Then, the composition solution is concentrated under reduced pressure by using a rotary evaporator until the weight before adding the solvent (B) is reached to obtain the composition of the present invention.

8. Application (Coating) of Composition

The invention also relates to a cured film produced from the composition according to the invention and a laminate comprising said film. The composition of the present invention is suitable as a hard coating, an antireflective film, or a coating material. As examples of the substrate to which the composition is applied, plastic (e.g. polycarbonate, polymethacrylate, polystyrene, polyester, polyolefin, epoxy resin, melamine resin, triacetyl cellulose resin, ABS resin, AS resin, and norbornene resin), metal, wood, paper, glass, slate, and the like can be given. The substrate may be in the shape of a plate, a film, or a three-dimensional formed product. As the coating method, an ordinary coating method such as dipping, spray coating, flow coating, shower coating, roll coating, spin coating, or brush coating can be given. The thickness of the coating after drying and curing is usually 0.1 to 400 μm, and preferably 1 to 200 μm.

9. Curing of Composition

The curable composition of the present invention may be cured by applying heat and/or radiation (light). When curing the composition by applying heat, an electric heater, infrared lamp, hot blast, or the like may be used as the heat source. When curing the composition by applying radiation (light), there are no specific limitations to the radiation source insofar as the composition can be cured in a short period of time after application. As examples of the source of infrared rays, a lamp, resistance heating plate, laser, and the like can be given. As examples of the source of visible rays, sunlight, a lamp, fluorescent lamp, laser, and the like can be given. As examples of the source of ultraviolet rays, a mercury lamp, halide lamp, laser, and the like can be given. As examples of the source of electron beams, a system utilizing thermoelectrons generated from a commercially available tungsten filament, a cold cathode method which generates electron beams by applying a high voltage pulse through a metal, and a secondary electron method which utilizes secondary electrons generated by collision between ionized gaseous molecules and a metal electrode can be given. As examples of the sources of α-rays, β-rays, and γ-rays, fissionable substances such as ⁶⁰Co and the like can be given. As the source of α-rays, a vacuum tube which causes accelerated electrons to collide with an anode or the like may be utilized. The radiation may be used either individually or in combination of two or more types. In the latter case, two or more types of radiation may be applied either simultaneously or at certain intervals of time.

The curing reaction of the composition of the present invention may be carried out in air or under anaerobic conditions such as in a nitrogen atmosphere. Even when the composition of the present invention is cured under anaerobic conditions, the resulting cured product exhibits excellent scratch resistance.

II. Cured Film

A cured film of the present invention may be obtained by applying the curable composition to a substrate such as a plastic substrate, and curing the applied composition. In more detail, the composition is applied to a substrate, and volatile components are dried at a temperature of preferably 0 to 200° C. Then, the composition is cured by applying heat and/or radiation as described above to obtain a coating formed product. When curing the composition by applying heat, the composition is preferably cured at 20 to 150° C. for 10 seconds to 24 hours. When curing the composition by applying radiation, it is preferable to use ultraviolet rays or electron beams. In this case, the dose of ultraviolet rays is preferably 0.01 to 10 J/cm², and still more preferably 0.1 to 2 J/cm². Electron beams are preferably applied at an accelerating voltage of 10 to 300 KV, an electron density of 0.02 to 0.30 mA/cm², and a dose of 1 to 10 Mrad.

Since the cured film of the present invention can form a coating (film) having high hardness, showing only a small amount of curling after immersion in hot water, and exhibiting excellent scratch resistance and excellent adhesion to a substrate or an adjacent layer such as a low-refractive-index layer, the cured film is particularly suitable as an antireflective film for film-type liquid crystal elements, touch panels, plastic optical parts, and the like.

III. Laminate

The cured film of the present invention is usually laminated on a substrate as a hard coating layer. A laminate suitable as an antireflective film may be formed by laminating a high-refractive-index layer and a low-refractive-index layer on the cured film (hard coating layer). The antireflective film may further include another layer. For example, pairs of a high-refractive-index layer and a low-refractive-index layer may be provided to form a wide-band antireflective film having relatively uniform reflectance characteristics for light over a wide wavelength range. Or, an antistatic layer may be provided.

There are no specific limitations to the substrate. When using the laminate as an antireflective film, plastic (e.g. polycarbonate, polymethyl methacrylate, polystyrene, polyester, polyolefin, epoxy resin, melamine resin, triacetyl cellulose (TAC) resin, ABS resin, AS resin, and norbornene resin) and the like can be given as the material for the substrate.

As the high-refractive-index film used in the present invention, a coating material cured film having a refractive index of 1.65 to 2.20 and containing metal oxide particles such as zirconia particles can be given, for example.

As examples of the low-refractive-index film used in the present invention, a metal oxide film made of magnesium fluoride or silicon dioxide, a fluorine-type coat material cured film, and the like having a refractive index of 1.38 to 1.45 can be given. When using a fluorine-type coat material cured film, fine particles having high hardness may be added in order to improve scratch resistance. As the fine particles having high hardness, silica particles or the like are preferable so that the refractive index of the low-refractive-index layer is not increased. The shape of the silica particles is not particularly limited. However, the refractive index can be further reduced by using hollow or porous silica particles having many voids inside the particles.

The laminate of the present invention formed by curing the curable composition of the present invention by applying ultraviolet rays shows only a small amount of curling when subjected to a hot water immersion treatment. When using a TAC film as the substrate, since the hot water immersion treatment may be performed in a saponification step, it is very useful from the industrial point of view if the laminate shows only a small amount of curling after the hot water immersion treatment. Moreover, the laminate exhibits improved steel wool scratch resistance.

It is estimated that the laminate or the cured film of the invention shows only a small amount of curling because the compound (B) shown by the formula (1) (isocyanuric acid derivative containing polymerizable unsaturated group) has a reaction rate and a polymerization conversion rate lower than those of the polyfunctional (meth)acrylate compound (C) other than the components (A) and (B) to reduce the internal stress. Moreover, since the component (B) (isocyanuric acid derivative containing polymerizable unsaturated group) contains a cyclic structure and has crystallinity, hardness is not decreased.

Furthermore, adhesion to the low-refractive-index layer and steel wool scratch resistance are improved by adding the component (B) (isocyanuric acid derivative containing polymerizable unsaturated group).

As a method of forming the low-refractive-index film on the high-refractive-index cured film obtained by curing the curable composition, vacuum deposition, sputtering, and the like can be given when forming a metal oxide film. When forming a fluorine-type coat material cured film, the above-described composition application (coating) method may be used.

Reflection of light on the surface of the substrate can be effectively prevented by layering the high-refractive-index cured film and the low-refractive-index film on the substrate.

Since the laminate of the present invention has excellent scratch resistance, low reflectance, and excellent chemical resistance, the laminate is particularly suitably used as an antireflective film for film-type liquid crystal elements, touch panels, plastic optical parts, and the like.

### EXAMPLES

The present invention is described below in detail by way of examples. However, the scope of the present invention is not limited to the following examples. In the examples, “part” refers to “part by weight” and “%” refers to “wt %” unless otherwise indicated.

### Preparation Examples 1

### Preparation of Zirconia Sol (Aa)

300 parts of spherical fine zirconia powder (“UEP-100” manufactured by Daiichi Kigenso Kagaku Kogyo Co., Ltd., primary particle size: 10 to 30 nm) was added to 700 parts of toluene, and dispersed by using glass beads for 168 hours. Then, the glass beads were removed to obtain 950 parts of toluene zirconia sol (Aa). 2 g of the dispersion sol was weighed on an aluminum dish and dried at 120° C. for one hour on a hot plate. The dried product was weighed to indicate that the solid content was 30%.

### Preparation Example 2

### Preparation of Organic Compound (Ab) Containing Polymerizable Unsaturated Group

222 parts of isophorone diisocyanate was added dropwise to a solution of 221 parts of mercaptopropyltrimethoxysilane and 1 part of dibutyltin dilaurate in dry air at 50° C. in one hour with stirring. The mixture was then stirred at 70° C. for three hours. After the dropwise addition of 549 parts of NK Ester A-TMM-3LM-N (manufactured by Shin-Nakamura Chemical Co., Ltd.; consisting of 60 wt % of pentaerythritol triacylate and 40 wt % of pentaerythritol tetraacrylate; only pentaerythritol triacylate containing hydroxyl group takes part in the reaction) at 30° C. in one hour, the mixture was stirred at 60° C. for 10 hours to obtain an organic compound (Ab) containing a polymerizable unsaturated group. The residual isocyanate content in the product analyzed by FT-IR was 0.1% or less. This indicates that the reaction completed almost quantitatively. In the infrared absorption spectrum of the product, the absorption peak at 2550 kayser characteristic of a mercapto group in the raw material and the absorption peak at 2260 kayser characteristic of the raw material isocyanate compound disappeared, and the absorption peak at 1660 kayser characteristic of a urethane bond and an S(C═O)NH— group and the absorption peak at 1720 kayser characteristic of an acryloxy group appeared. This indicates that an acryloxy group-modified alkoxysilane containing an acryloxy group, —S(C═O)NH— group, and urethane bond was produced. The above reaction yielded 773 parts of compounds shown by the formulas (4-1) and (4-2). The product also contained 220 parts of pentaerythritol tetraacrylate which did not take part in the reaction.

### Preparation Example 3

### Preparation of Urethane (Meth)Acrylate (C-2) (Compound Shown by Formula (5))

A vessel equipped with a stirrer was charged with a solution of 18.8 parts of isophorone diisocyanate and 0.2 parts of dibutyltin dilaurate. After the dropwise addition of 93 parts of NK Ester A-TMM-3LM-N (manufactured by Shin-Nakamura Chemical Co., Ltd.; only pentaerythritol triacylate containing hydroxyl group takes part in the reaction) at 10° C. in one hour, the mixture was stirred at 60° C. for six hours to obtain a reaction liquid (urethane (meth)acrylate (C-2)).

The residual isocyanate content in the reaction liquid measured by FT-IR in the same manner as in Preparation Example 1 was 0.1 wt % or less. This indicates that the reaction completed almost quantitatively. It was confirmed that a urethane bond and an acryloyl group (polymerizable unsaturated group) were included in the molecule.

The above reaction yielded 75 parts of a compound shown by the formula (5). The product also contained 37 parts of pentaerythritol tetraacrylate which did not take part in the reaction.

### Preparation Example 4

### Preparation of Reactive Zirconia Powder Sol (A-1)

A mixed solution of a mixture of 1.16 parts of the organic compound (Ab) containing a polymerizable unsaturated group prepared in Preparation Example 2 and pentaerythritol tetraacrylate, 237 parts of the toluene zirconia sol (Aa) (zirconia content: 30%) prepared in Preparation Example 1, 0.1 part of ion-exchanged water, and 0.03 part of p-hydroxyphenyl monomethyl ether was stirred at 60° C. for three hours. After the addition of 1.0 part of methyl orthoformate, the mixture was stirred at 60° C. for one hour to obtain reactive particles (liquid dispersion (A-1)). 2 g of the liquid dispersion (A-1) was weighed on an aluminum dish and dried on a hot plate at 120° C. for one hour. The dried product was weighed to indicate that the solid content was 31%. 2 g of the liquid dispersion (A-1) was weighed in a magnetic crucible, predried on a hot plate at 80° C. for 30 minutes, and sintered at 750° C. for one hour in a muffle furnace. The inorganic content in the solid content was determined from the inorganic residue. As a result, the inorganic content was 93%.

### Preparation Example 5

### Preparation of Curable Composition (Coating Liquid A) for Low-Refractive-Index Film

(1) Preparation Of Fluorine-Containing Polymer Containing Hydroxyl Group

The atmosphere inside a stainless steel autoclave (2.0 L) equipped with an electromagnetic stirrer was sufficiently replaced with nitrogen gas. Then, the autoclave was charged with 500 g of ethyl acetate (solvent), 43.2 g of perfluoro(propyl vinyl ether), 21.5 g of hydroxyethyl vinyl ether, 41.2 g of ethyl vinyl ether, 1.3 g of lauroyl peroxide, 6.0 g of a silicone-containing polymer azo initiator (“VPS-1001” manufactured by Wako Pure Chemical Industries, Ltd.), and 40.5 g of a reactive emulsifier (“NE-30” manufactured by Asahi Denka Kogyo KK). After cooling the mixture to −50° C. with dry ice-methanol, oxygen contained in the system was removed by nitrogen gas.

After the addition of 97.4 g of hexafluoropropylene, the temperature of the mixture was increased. The pressure when the temperature inside the autoclave reached 60° C. was 5.3×10⁵ Pa. The reaction was allowed to proceed at 70° C. for 20 hours with stirring. When the pressure was decreased to 1.7×10⁵ Pa, the autoclave was cooled with water to terminate the reaction. After the reaction product was cooled to room temperature, unreacted monomers were removed and the autoclave was opened to obtain a polymer solution. The resulting polymer solution was poured into methanol to precipitate the polymer. Then, the precipitate washed with methanol and dried under vacuum at 50° C. to obtain 220 g of a fluorine-containing polymer containing a hydroxyl group.

It was found that the resulting fluorine-containing polymer had a 3.5×10⁻⁵ mol/g.

(ii) Preparation of Methyl Ethyl Ketone Dispersion Hydrophobized Colloidal Silica

0.6 kg of trimethylmethoxysilane (manufactured by Toray-Dow Corning Silicone Co. Ltd.) was added to 20 kg of the methanol dispersion colloidal silica prepared in (ii). The mixture was stirred at 60° C. for three hours. The number average particle diameter determined by a dynamic light scattering method was 11 nm, which is the same as the value before stirring. The specific surface area of the resulting hydrophobized colloidal silica dispersed in methanol measured by a BET method was 240 m²/g. The silanol group concentration on the silica particles determined by a methyl red adsorption method was 2.1×10⁻⁵ mol/g.

After the addition of 14 kg of methyl ethyl ketone to the above hydrophobized colloidal silica, the mixture was then concentrated at 50° C. at a circulation flow rate of 501/minute and pressure of 1 kg/cm² using the above ultrafilter membrane module and ultrafilter membrane to discharge 14 kg of filtrate. This step was repeated five times to prepare 20 kg of methyl ethyl ketone dispersion hydrophobized colloidal silica (silica particle sol) with a solid content of 30 wt %, a water content determined by the Karl Fischer method of 0.3 wt %, a methanol content determined by gas chromatography (GC) of 3.2 wt %, and a number average particle diameter determined by a dynamic light scattering method of 11 nm. The average permeation flow rate of five times of operation was 70 kg/m²/hour, which required four hours. The specific surface area of the resulting methyl ethyl ketone dispersion hydrophobized colloidal silica measured by the BET method was 230 m²/g. The silanol group concentration on the silica particles determined by a methyl red adsorption method was 1.8×10⁻⁵ mol/g. The metal content in the solvent of the methyl ethyl ketone dispersion hydrophobized colloidal silica determined by an atomic absorption method was as low as 0.05 ppm for Na and 0.001 ppm for Ca and K, respectively.

(iii) Treatment of Silica Particle by Using Silane Coupling Agent

A mixture of 3.7 parts of 3-mercaptopropyltrimethoxysilane, 93.2 parts of the silica particle sol prepared in (ii) (28 parts as silica particles), and 0.25 part of ion-exchanged water was stirred at 60° C. for three hours. After the addition of 2.9 parts of methyl orthoformate, the mixture was stirred at 60° C. for one hour to obtain a silica particle sol treated with a silane coupling agent. 2 g of the sol was weighed on an aluminum dish and dried at 175° C. for one hour on a hot plate. The dried product was polystyrene-reduced number average molecular weight (Mn) determined by gel permeation chromatography of 48,000, a glass transition temperature (Tg) by differential scanning calorimetry (DSC) of 26.8° C., and a fluorine content determined by an alizarin complexone method of 50.3%.

(2) Preparation of Particles Containing Silica as Major Component

(i) Preparation of Methanol Dispersion Colloidal Silica

A tank was charged with 30 kg of colloidal silica dispersed in water (“Snowtex-O” manufactured by Nissan Chemical Industries, Ltd., solid content: 20 wt %, pH: 2.7, specific surface area measured by BET method: 226 m²/g, silanol group concentration on silica particles determined by methyl red adsorption method: 4.1×10⁻⁵ mol/g, metal content in solvent determined by atomic absorption method: Na; 4.6 ppm, Ca; 0.013 ppm, K; 0.011 ppm). The colloidal silica was concentrated at 50° C. at a circulation flow rate of 50 l/minute and pressure of 1 kg/cm² using an ultrafilter membrane module (manufactured by Tri Tec Corporation) and an ultrafilter membrane made of alumina (“Ceramic UF Element” manufactured by NGK Insulators, Ltd., specification: 4 mm in diameter, 19 pores, length; 1 m, fractional molecular weight=150,000, membrane area=0.24 m²). After 30 minutes, 10 kg of filtrate was discharged to obtain a residue with a solid content of 30 wt %. The average permeation flow rate (membrane permeation weight per unit area of ultrafilter membrane and unit time) before concentration was 90 kg/m²/hour. After concentration, the average permeation flow rate was 55 kg/m²/hour. The number average particle diameter determined by a dynamic light scattering method was 11 nm before and after concentration.

After the addition of 14 kg of methanol to the above colloidal silica, the mixture was then concentrated at 50° C. at a circulation flow rate of 501/minute and pressure of 1 kg/cm² using the above ultrafilter membrane module and ultrafilter membrane to discharge 14 kg of filtrate. This step was repeated six times to prepare 20 kg of colloidal silica dispersed in methanol with a solid content of 30 wt %, water content determined by the Karl Fischer method of 1.5 wt %, and number average particle diameter determined by a dynamic light scattering method of 11 nm. The average permeation flow rate of six times of operation was 60 kg/m²/hour, requiring six hours for the operation to complete. The specific surface area of the resulting colloidal silica dispersed in methanol measured by the BET method was 237 m²/g. The silanol group concentration on the silica particles determined by a methyl red adsorption method was weighed to indicate the solid content was 31 wt %.

(3) Preparation of Curable Composition (Coating Liquid A) for Low-Refractive-Index Film

4.3 g of the silica particle sol obtained in (2) (iii), 5.6 g of the fluorine-containing polymer containing a hydroxyl group obtained in (1), 1.7 g of methoxylated methyl melamine “Cymel 303” (manufactured by Mitsui-Cytec, Ltd.) (crosslinkable compound), and 0.63 g of “Catarist 4050” (manufactured by Mitsui-Cytec, Ltd.; aromatic sulfonic acid compound) (curing catalyst) were dissolved in 208 g of methyl ethyl ketone (solvent) to obtain a coating liquid A. The solid content of the coating liquid A determined by the same method as in (iii) was 4 wt %.

### Example 1

(1) Preparation of Curable Composition

In a UV shielded vessel, 123.1 parts of the reactive zirconia fine powder sol (liquid dispersion (A-1)) prepared in Preparation Example 4 (reactive zirconia: 35.9 parts), 25 parts of isocyanuric acid EO-modified triacylate (B-1), 33.9 parts of pentaerythritol triacrylate (“Kayarad DDP-2C” manufactured by Nippon Kayaku Co., Ltd.) (C-1), 1.3 parts of urethane (meth)acrylate ((C-2), 0.9 part of pentaerythritol tetraacrylate (C-3), 1.9 parts of 1-hydroxycyclohexyl phenyl ketone (D-1), 1.1 parts of 2-methyl-1-[4-(methylthio)phenyl]-2-morpholinopropanon-1 (D-2), and 5.0 parts of toluene, and 18.5 parts of methyl ethyl ketone (MEK) were stirred at 30° C. for two hours to obtain a homogeneous composition solution. The pentaerythritol tetra(meth)acrylate (C-3) originates in pentaerythritol tetraacrylate in the organic compound (Ab) and the urethane (meth)acrylate (C-2). The solid content of the composition determined in the same manner as in Preparation Example 4 was 50%.

(2) Preparation of Cured Film (High-Refractive-Index Film)

The composition obtained in (1) was applied to a TAC film by using a coater equipped with a wire bar (#6) appropriate for the film thickness, and dried at 80° C. for one minute in an oven to form a coating. The coating was cured by applying ultraviolet rays in air at a dose of 0.3 J/cm² by using a high-pressure mercury lamp to form a TAC film provided with a high-refractive-index film having a thickness of 3 μm. The curling properties, haze, refractive index, and scratch resistance of the resulting cured film (high-refractive-index film) were evaluated. The results are shown in Table 1.

(3) Preparation of Antireflective Film Laminate

The curable composition for a low-refractive-index film (coating liquid A) obtained in Preparation Example 5 was applied to the TAC film provided with a high-refractive-index film having a thickness of 3 μm by using a wire bar coater (#3), and air-dried at room temperature for five minutes. The curable composition was cured at 120° C. for 10 minutes in an oven to form a low-refractive-index film having a thickness 100 nm to obtain an antireflective film laminate. The scratch resistance of the resulting laminate was evaluated. The results are shown in Table 1.

### Examples 2 to 7 and Comparative Examples 1 and 2

Curable compositions, cured films, and antireflective film laminates of Examples 2 to 7 and Comparative Examples 1 and 2 were obtained in the same manner as in Example 1 except for changing the composition as shown in Table 1. The properties of the resulting cured films and antireflective film laminates were evaluated. The results are shown in Table 1.

Property Evaluation Method and Evaluation Criteria

(1) Curling

The resulting TAC film provided with a high-refractive-index film was cut into a square with a size of 10×10 cm and placed on a horizontal plane. The average value of the distances of the four corners from the horizontal plane was taken as the value of curling (immediately after curing).

The film was immersed in hot water at 50° C. for three minutes, and the value of curling (after hot water immersion) was measured by using the same method.

(2) Haze (%)

The haze value of the TAC film provided with a high-refractive-index film was measured according to JIS K 7105 by using a color haze meter (manufactured by Suga Test Instruments Co., Ltd.).

(3) Refractive Index

The curable compositions obtained in Examples 1 to 7 and Comparative Examples 1 and 2 were applied to untreated PET (“Lumirror 100T-60” manufactured by Toray Industries Inc.) by using a bar coater, and dried at 80° C. for three minutes. The coating was cured by applying ultraviolet rays at a does of 300 mJ/cm² using a high-pressure mercury lamp. The cured product was removed from the untreated PET. It was confirmed that the thickness of the cured product was 40±10 μm by using a thickness meter. The refractive index of the cured product (n_{D}²⁵) was measured by using an Abbe's refractometer according to JIS K 7105.

(4) Scratch Resistance

The surface of the high-refractive-index film before and after hot water immersion was rubbed with #0000 steel wool 10 times at a load of 100 g/cm² to measure the number of scratches.

A coating with a number of scratches of eight or less can be used without problem in actual application. A coating with a number of scratches of five or less exhibits excellent durability in actual application, and a coating with a number of scratches of three or less exhibits significantly improved durability in actual application.

TABLE 1

| | | | | | | | Comparative | |
|---|---|---|---|---|---|---|---|---|
| | Example | | | | | | Example | |
| Composition (wt %) | 1 | 2 | 3 | 5 | 6 | 7 | 1 | 2 |
| Reactive zirconia particles (A-1) | 35.9 | 35.9 | 35.9 | 48.8 | 60.6 | 41.0 | 35.9 | — |
| Zirconia particles (Aa) | — | — | — | — | — | — | — | 35 |
| Isocyanuric acid EO-modified triacylate (B-1) | 25 | 12.5 | 40 | 30.8 | 15.4 | 40.9 | — | 25 |
| Pentaerythritol triacylate (C-1) | 33.9 | 46.4 | 18.9 | 12.6 | 15.5 | 10.6 | 58.9 | 34.8 |
| Pentaerythritol tetraacrylate (C-3) | 0.9 | 0.9 | 0.9 | 1.2 | 1.5 | 1.1 | 0.9 | 0.9 |
| Compound shown by the formula (5) (C-2) | 1.3 | 1.3 | 1.3 | 1.8 | 2.2 | 1.6 | 1.3 | 1.3 |
| 1-Hydroxycyclohexyl phenyl ketone (D-1) | 1.9 | 1.9 | 1.9 | 4.8 | 4.8 | 4.8 | 1.9 | 1.9 |
| 2-Methyl-1-[4-(methylthio)phenyl]-2- | 1.1 | 1.1 | 1.1 | — | — | — | 1.1 | 1.1 |
| morpholinopropanone-1 (D-2) | | | | | | | | |
| Total | 100 | 100 | 100 | 100 | 100 | 100 | 100 | 100 |
| Toluene | 50 | 50 | 50 | 50 | 50 | 50 | 50 | 50 |
| MEK | 50 | 50 | 50 | 50 | 50 | 50 | 50 | 50 |
| Solid content | 50 | 50 | 50 | 50 | 50 | 50 | 50 | 50 |
| <Property evaluation> | | | | | | | | |
| (1) Curling (immediately after curing) (mm) | 7 | 10 | 6 | 4 | 6 | 4 | 27 | 8 |
| Curling (after hot water immersion) (mm) | 17 | 21 | 8 | 14 | 17 | 12 | 32 | 19 |
| (2) Haze (%) | 0.5 | 0.7 | 0.5 | 0.4 | 0.5 | 0.9 | 0.4 | 0.7 |
| (3) Refractive index | 1.57 | 1.57 | 1.58 | 1.63 | 1.65 | 1.59 | 1.58 | 1.57 |
| (4) Scratch resistance | | | | | | | | |
| Single layered hard coating (before hot water immersion) | 0 | 0 | 0 | 0 | 0 | 0 | 0 | 0 |
| Single layered hard coating (after hot water immersion) | 0 | 0 | 0 | 0 | 0 | 0 | 0 | 10 |
| Antireflective film laminate | 4 | 2 | 0 | 5 | 6 | 4 | 10 | 10 |

In Table 1, the amount of the reactive zirconia particles (A-1) indicates the fine powder dry weight (excluding organic solvent).

The meanings of the abbreviations shown in Table 1 are as follows.

Reactive zirconia particles (A-1): reactive zirconia particles obtained in Preparation Example 4

Zirconia particles (Aa): zirconia sol obtained in Preparation Example 1

Isocyanuric acid EO-modified triacylate (B-1): “Aronix M315” manufactured by Toagosei Co., Ltd.

Pentaerythritol triacylate (C-1): “Kayarad DPET-30” manufactured by Nippon Kayaku Co., Ltd.

1-Hydroxycyclohexyl phenyl ketone (D-1): Irgacure 184 manufactured by Ciba Specialty Chemicals Co., Ltd.

2-Methyl-1-[4-(methylthio)phenyl]-2-morpholinopropanone-1 (D-2): Irgacure 907 manufactured by Ciba Specialty Chemicals Co., Ltd.

MEK: Methyl ethyl ketone

From the results shown in Table 1, the cured film of the example has a high refractive index, shows only a small amount of curling after hot water immersion, and exhibits excellent scratch resistance after hot water immersion. On the other hand, the cured film of Comparative Example 1, which does not contain the component (B-1), shows a large amount of curling immediately after curing, and shows a larger amount of curling after hot water immersion. The scratch resistance of the cured film of Comparative Example 2, which does not contain the component (A-1), is significantly decreased after hot water immersion.

While the antireflective film laminate of the example exhibits excellent scratch resistance, the antireflective film laminate of the comparative example exhibits poor scratch resistance.

As described above, the curable composition and the cured product of the present invention can be suitably used as a protective coating material for preventing occurrence of scratches or stains of plastic optical parts, touch panels, film-type liquid crystal elements, plastic containers, and flooring materials, wall materials, and artificial marbles used as architectural interior finish; an antireflective film for film-type liquid crystal elements, touch panels, or plastic optical parts; an adhesive or a sealing material for various substrates; a binder for printing ink; and the like. The curable composition and the cured product can be particularly suitably used as an antireflective film.

The curable composition and the cured product of the present invention are particularly suitable as an optical material for which a high refractive index is required, such as an antireflective film high-refractive-index material and a lens material.

1. A curable composition, comprising: (A) 5 to 70 wt % of metal oxide particles having a refractive index of 1.50 or more, to which an organic compound including a polymerizable unsaturated group is bonded; and (B) 10 to 50 wt % of a compound shown by the following formula (1), the amount of each component being based on the total amount of the composition excluding a solvent, 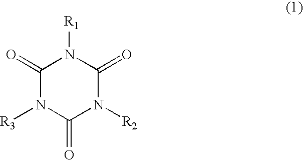
wherein R¹, R², and R³ individually represent monovalent organic groups, with at least two of R¹ to R³ being —R₄OCOCR₅═CH₂, R⁴ represents a divalent organic group having 2 to 8 carbon atoms, and R⁵ represents a hydrogen atom or a methyl group.

2. The curable composition according to claim 1, wherein the component (B) is tris((meth)acryloxyethyl)isocyanurate.

3. The curable composition according to claim 1 or 2, wherein the organic compound in the component (A) contains a group shown by the following formula (2) in addition to the polymerizable unsaturated group, 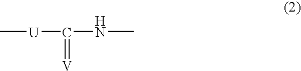
wherein U represents NH, O (oxygen atom), or S (sulfur atom), and V represents O or S.

4. The curable composition according to claim 3, wherein the organic compound in the component (A) is a compound containing a silanol group in the molecule or a compound which forms a silanol group by hydrolysis.

5. The curable composition according to any of claims 1 to 4, further comprising (C) 5 to 20 wt % of a polyfunctional (meth)acrylate compound other than the components (A) and (B) based on the total amount of the composition excluding a solvent.

6. The curable composition according to any of claims 1 to 5, comprising the component (B) in an amount of 20 wt % or more of 100 wt % of the total (meth)acrylate component in the composition excluding the component (A).

7. A cured film produced by curing the curable composition according to any of claims 1 to 6.

8. A laminate, comprising the cured film according to claim 7.
